(19) United States
(12) Patent Application Publication
(10) Pub. No.: US 2014/0292613 A1
(43) Pub. Date: Oct. 2, 2014

(54) HINGE ANTENNA AND FOLDABLE ELECTRONIC DEVICE USING THE SAME

(71) Applicant: Advanced-Connetek Inc., New Taipei City (TW)

(72) Inventors: Fu-Ren HSIAO, New Taipei City (TW); Chih-Fan CHEN, New Taipei City (TW)

(73) Assignee: Advanced-Connetek Inc., New Taipei City (TW)

(21) Appl. No.: 14/224,840

(22) Filed: Mar. 25, 2014

(30) Foreign Application Priority Data
Mar. 28, 2013 (TW) 102111230

(51) Int. Cl. H01Q 1/22

(52) U.S. Cl. CPC H01Q 1/2266
USPC 343/905

(57) ABSTRACT

A hinge antenna comprises a metal hinge, a first metal connecting plate and a second metal connecting plate. The hinge antenna further comprises a microwave substrate, a signal feeding line, and a conductor, wherein the conductor is electrically connected to the microwave substrate and extended from the microwave substrate. Furthermore, the feed line of the signal feeding line is electrically connected to the microwave substrate and the ground line of the signal feeding line is electrically connected to the metal hinge, the first metal connecting plate, the second metal connecting plate, and an outside metal shield so that the metal hinge, the first metal connecting plate, the second metal connecting plate, and the outside metal shield can serve as a ground. The aforementioned configuration is utilized to form an antenna loop. In addition, the configuration of this antenna can be built in the interior space of the foldable electronic device.

### BACKGROUND OF THE INVENTION

1. Technical Field

The present invention relates to a hinge antenna, and in particular to a hinge antenna can be used in a foldable electronic device. The antenna element is integrated with a hinge within the foldable electronic device, such that the hinge antenna can be accommodated within the interior space in the foldable electronic device. With such antenna structure, the effects of stabilization in structure, simplification in assembly and unification in appearance can be achieved.

2. Description of the Prior Art

With the rapid development of technologies, varieties of portable 3C electronic devices provide convenience for human life, and thus become indispensable. In recent years, due to the rapid growth of wireless communication, a large amount of data is transmitted to portable 3C electronic devices via wireless networks. As been an integrated configuration of portable 3C electronic device, it is necessary for antennas to be built in the 3C electronic device for receiving signals sent from wireless base stations. For example, it is common to see travelling people carrying laptops and communicating via networks for attaining needed information. The antenna is built in each laptop for receiving signals.

Referring to FIG. 6, it is a schematic view showing a conventional antenna structure. As shown in FIG. 6, in general, one antenna is disposed on each of the left and right sides of the upper end of the laptop display screen in a symmetric manner, and the high-frequency coaxial cables are employed for the transmission of signals, as indicated in the dashed line in the figure. Since signal degradation, such as insertion loss, occurs when signals are transmitted by using coaxial cables, the effective transmission distance and signal quality are reduced. In addition, such signal degradation is more severe in the coaxial cable during wireless transmission in higher frequency. Moreover, the shell of the laptops is commonly made of metal which creates shielding effect and as results the signal reception of the antenna is affected.

### SUMMARY OF THE INVENTION

In view of the aforementioned long-existing problems, the present invention provides a hinge antenna, which can be effectively accommodated within a foldable electronic device. The hinge antenna includes a metal shaft, a first metal connecting plate and a second metal connecting plate. The first metal connecting plate and the second metal connecting plate are rotated by the metal shaft with respect to the metal hinge. The hinge antenna includes a signal feeding line, a microwave substrate and a conductor. The conductor, the metal shaft, the first metal connecting plate and the second metal connecting plate are configured to form a monopole antenna, a planar inverted-F antenna or loop antenna. Thus, the hinge antenna transmits the electromagnetic wave signal to the outer housing of the electronic device to construct an antenna loop for improving the radiation area and the antenna performance. With the design of the hinge antenna of the present invention, the effect of stabilization in structure, simplification in assembly and unification in appearance can be achieved without affecting the signal-receiving the signal-receiving quality of the antenna.

According to the description above, a major objective of the present invention is to provide a hinge antenna, and the metal shaft of the metal hinge drives the first metal connecting plate and the second metal connecting plate to rotate with respect to the metal hinge, in which the hinge antenna includes a signal feeding line and a conductor. The hinge antenna is the main part of antenna which is arranged extendedly outward along the second metal connecting plate and is electrically connected to the signal feeding line. Therefore, there is no need to additionally install a micro-scale antenna that may influence the quality of electromagnetic signal transmission and reception. As resulted, the effect of structure stabilization, simplification and appearance unification can be achieved.

Another major objective of the present invention is to provide a hinge antenna and the metal shaft of the metal hinge drives the first metal connecting plate and the second metal connecting plate to rotate with respect to the metal hinge. The hinge antenna includes a signal feeding line, a microwave substrate and a conductor. The hinge antenna is the antenna body extended outwardly along the microwave substrate and is electrically connected with a matching circuit such that the matching circuit on the microwave substrate can adjust the work bandwidth of the hinge antenna, so there is no need to additionally install a micro-scale antenna that may influence the quality of electromagnetic signal transmission and reception. As resulted, the effects of structure stabilization, assembly simplification and appearance unification can be achieved.

Still another major objective of the present invention is to provide a hinge antenna accommodated within an interior space of a first housing and a second housing of a foldable electronic device. The hinge antenna utilizes the metal shaft to rotate the first metal connecting plate and the second metal connecting plate with respect to the metal hinge, in which the hinge antenna is connected to the metal shaft on the metal hinge of the foldable electronic device. The hinge antenna includes a signal feeding line and a conductor. The antenna body of the hinge antenna is extended outwardly along the second metal connecting plate, so there is no need to additionally install a micro scale antenna that may influence the quality of electromagnetic signal transmission and reception. As resulted, the effects of structure stabilization, assembly simplification and the shielding effect of metals can be suppressed.

Another major objective of the present invention is to provide a hinge antenna accommodated within an interior space of a first housing and a second housing of a foldable electronic device. The hinge antenna utilizes the metal shaft to rotate the first metal connecting plate and the second metal connecting plate with respect to the metal hinge. The hinge antenna includes a signal feeding line, a microwave substrate and a conductor. The antenna body of the hinge antenna is extended outwardly along the microwave substrate and is electrically connected to the matching circuit on the microwave substrate. The matching circuit can adjust the work bandwidth of the hinge antenna and there is no need to additionally install a micro-scale antenna that may influence the quality of electromagnetic signal transmission and reception, and shielding effect of metals can be suppressed.

According to the objectives above, the present invention provides a hinge antenna, which includes a metal hinge, a first metal connecting plate and a second metal connecting plate. One end of the first metal connecting plate and one end of the second metal connecting plate is connected to a metal joint plate. The metal hinge jointed the first metal connecting plate and the second metal connecting plate through the metal joint plate. The metal hinge further includes a metal shaft which is arranged in the metal joint plate and the first metal connecting plate and the second metal connecting plate are rotated by the metal shaft with respect to the metal hinge, the characteristic of the hinge antenna in that: a signal feeding line is provided for feeding an electromagnetic wave signal and a conductor is arranged on the second metal connecting plate and is electrically connected to one end of the signal feeding line, in which the conductor is made by metallic materials with geometric configuration.

According to the objectives above, the present invention provides a hinge antenna, which includes a metal hinge, a first metal connecting plate and a second metal connecting plate. One end of the first metal connecting plate and one end of the second metal connecting plate are connected to a metal joint plate respectively. The metal hinge jointed the first metal connecting plate and the second metal connecting plate through the metal joint plate. The metal hinge includes a metal shaft and the metal shaft is arranged in the metal joint plate. The first metal connecting plate and the second metal connecting plate are rotated by the metal shaft with respect to the metal hinge, the characteristic of the hinge antenna in that: a signal feeding line is provided for feeding an electromagnetic wave signal, a microwave substrate is arranged on the second metal connecting plate and having a signal feeding section and a grounding section. One end of the signal feeding section is electrically connected to one end of the signal feeding line and the grounding section is electrically connected to the second metal connecting plate. A conductor is arranged on the microwave substrate and is electrically connected to another end of the signal feeding second, in which the conductor is made by metallic materials with geometric configuration.

According to the objectives above, the present invention further provides a foldable electronic device which includes at least a hinge antenna, a first housing and a second housing. The hinge antenna includes a metal hinge, a first metal connecting plate and a second metal connecting plate. One end of the first metal connecting plate and one end of the second metal connecting plate is connected to a metal joint plate. The metal hinge is connected to the first metal connecting plate and the second metal connecting plate through the metal joint plate respectively. The metal hinge further includes a metal shaft which is arranged in the metal joint plate and the first metal connecting plate and the second metal connecting plate are rotated by the metal shaft with respect to the metal hinge. The first housing and the second housing are fixed on the first metal connecting plate and the second metal connecting plate respectively such that the first housing and the second housing are rotationally displaced with respect to the metal shaft as the center, the characteristic of the hinge antenna in that: a signal feeding line is provided for feeding an electromagnetic wave signal and a conductor is arranged on the second metal connecting plate and is electrically connected to one end of the signal feeding line, in which the conductor is made by the metallic materials with geometric configuration.

According to the objectives above, the present invention still provides a foldable electronic device, which includes at least a hinge antenna, a first housing and a second housing. The hinge antenna includes a metal hinge, a first metal connecting plate and a second metal connecting plate, and one end of the first metal connecting and one end of the second metal connecting plate is connected to a metal joint plate respectively. The metal hinge is jointed the first metal connecting plate and the second metal connecting plate through the metal joint plate. The metal hinge further includes a metal shaft which is arranged in the metal joint plate and the first metal connecting plate and the second metal connecting plate are rotated with respect to the metal hinge by the metal shaft. The first housing and the second housing are fixedly connected to the first metal connecting plate and the second metal connecting plate respectively, such that the first housing and the second housing are rotationally displaced with respect to the metal shaft as the center, the characteristic of the hinge antenna in that: a signal feeding line is provided for feeding an electromagnetic wave signal, a microwave substrate is arranged on the second metal connecting plate and having a signal feeding section and a grounding section. One end of the signal feeding section is electrically connected to one end of the signal feeding line and the grounding section is electrically connected to the second metal connecting plate. A conductor is arranged on the microwave substrate and is electrically connected to another end of the signal feeding section, and the conductor is made by the metallic materials with geometric configuration.

With the hinge antenna and the foldable electronic device with the hinge antenna provided by the present invention, the effects of structure stabilization, assembly simplification and appearance unification can be achieved. Furthermore, the manufacturing process can be effectively shortened and the yield can be improved as a result.

### BRIEF DESCRIPTION OF THE DRAWINGS

FIG. 1 is a schematic view of a hinge antenna according to a first embodiment of the present invention.

FIG. 2A is another schematic view of the hinge antenna according to the first embodiment of the present invention.

FIG. 2B is a further schematic view of the hinge antenna according to a first embodiment of the present invention.

FIG. 3 is a schematic view of a hinge antenna according to a second embodiment of the present invention.

FIG. 4 is another schematic view of the hinge antenna according to the second embodiment of the present invention.

FIG. 5A is a schematic view showing the application of the first embodiment in a foldable electronic device according to the present invention.

FIG. 5B is another schematic view showing the application of the first embodiment in a foldable electronic device according to the present invention.

FIG. 6 is a schematic view showing a conventional antenna structure.

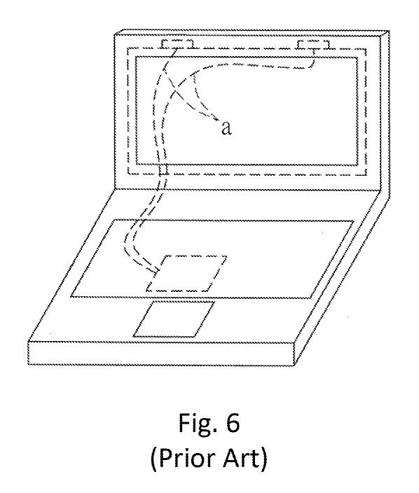

### DETAILED DESCRIPTION OF THE PREFERRED EMBODIMENT

The present invention major provides a hinge antenna and a foldable electronic device with a hinge antenna, the main technical means is that the conductor is extended directly and is connected to the hinge for assembling. The hinge and the conductor are configured to form an antenna structure and the hinge is electrically connected to the metallic housing of the electronic device, such that the radiation area of the whole antenna can be increased and the antenna performance can be improved. Thus, there is no need to additionally install a micro-scale antenna that may influence the quality of electromagnetic signal transmission and reception. As resulted, the effects of structure stabilization, assembly simplification and the shielding effect of metals can be suppressed. In addition, the present invention with the basic principles and functions of the antenna has knowledge of the relevant art who can understand clearly. In the following of the description, only for the characteristics of the hinge antenna and the foldable electronic device with the hinge antenna of the present invention to describe in detailed. Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

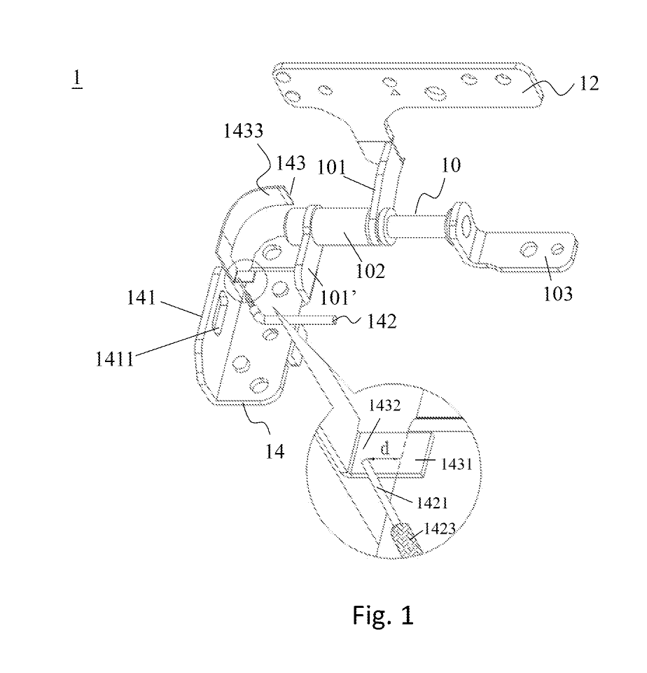

First, please refer to FIG. 1. FIG. 1 is a schematic view of a hinge antenna according to a first embodiment of the present invention. As shown in FIG. 1, the hinge antenna 1 includes a metal hinge 10, a first metal connecting plate 12 and a second metal connecting plate 14. One end of the first metal connecting plate 12 and one end of the second metal connecting plate 14 is connected to a metal joint plate 101 and a metal joint plate 101′ respectively. The metal hinge 10 is jointed the first metal connecting plate 12 through the metal joint plate 101 and metal hinge 10 is also jointed the second metal connecting plate 14 through the metal joint plate 101′. The metal hinge 10 further includes a metal shaft 102 which is arranged and penetrated within the metal joint plate 101 and the metal joint plate 101′, such that the first metal connecting plate 12 and the second metal connecting plate are rotated by the metal shaft 103 with respect to the metal hinge 10. The metal shaft 10, the metal joint plate 101, the metal joint plate 101′ the first metal connecting plate 12 and the second metal connecting plate 14 are made by stamping the metallic materials. A plurality of through holes in the first metal connecting plate 12 and in the second metal connecting plate 14 is used for locking the outer housing (for example, the housing of the foldable electronic device). As aforementioned, the size or the configuration for the first metal connecting plate 12 and the second metal connecting plate 14 are not limited in the present invention.

In addition, the hinge antenna 1 further includes a signal feeding line 142 which is provided for feeding an electromagnetic wave signal. The signal feeding line 142 is a coaxial cable. The hinge antenna 1 also includes a conductor 143 which is arranged on the second metal connecting plate 14 and is electrically connected to one end of the signal feeding line 142. In one preferred embodiment of the present invention, the conductor 143 is made by a metallic material with geometric configuration. The conductor 143, the first metal connecting plate 12 and the second metal connecting plate 14 are configured to form a planar inverted-F antenna. Please further refer to the explosive view of dotted line in FIG. 1. The conductor 143 further includes a connecting section 1431, a signal feeding section 1432 and a radiation section 1433. The conductor 143 is fixed on the second metal connecting plate directly and is connected to one end of the signal feeding line 142 through the signal feeding section 1432 and the conductor 143 received and transmitted the electromagnetic wave signal through the radiation section 1433 of an extension section of the signal feeding section 1432. The conductor 143 can cooperate to the foldable electronic device to be combined, and the conductor 143 is extended vertically upward or downward along one side of the second metal connecting plate 14. The conductor 143 can fix on the second metal connecting plate 14 by welding or the conductor 143 is integrated with the second metal connecting plate 14 but it would not be limited in the present invention. Furthermore, when the signal feeding line 142 is constructed by a coaxial cable which includes a pair and isolated inner conductor of the coaxial cable 1421 and an outside metal shield of the coaxial cable 1423 and an insulation shielding layer (not shown) covered outside of the coaxial cable. One end of the inner conductor of the coaxial cable 1421 of the signal feeding line 132 is electrically connected to the signal feeding section 1432 of the conductor 143 and the outside metal shield of the coaxial cable 1423 of the signal feeding line 142 is electrically connected to the second metal connecting plate 14 (as for electrical connecting to the ground line). Because there is a distance “d” between the electrically connecting position of the inner conductor of the coaxial cable 1421 and that of the outside metal shield of the coaxial cable 1423, the distance “d” can achieve the purpose for adjusting the impedance matching and can prevent the short circuit of the inner conductor of the coaxial cable 1421 from the radiation influence of the second metal connecting plate 14 for receiving and transmitting the electromagnetic wave signal. The distance “d” is range from 5 mm to 10 mm or a longer distance. Obviously, the metal shaft 10, the metal joint plate 101, the metal joint plate 101′, the first metal connecting plate 12 and the second metal connecting plate 14 are formed by stamping metallic plate. When the outside metal shield of the coaxial cable 1423 of the signal feeding line 142 is connected to the second metal connecting plate 14 that means the components such as the outside metal shield of the coaxial cable 1423 of the signal feeding line 142 is integrated with the metal hinge 10, the metal joint plate 101, the metal joint plate 101′ the first metal connecting plate 12 and the second metal connecting plate 14 which are used for connecting to the outer housing (such as the housing of the foldable electronic device) and are commonly grounded.

According to aforementioned, the electromagnetic wave signal is received by the conductor 143 and is transmitted to the internal circuit (such as internal circuit within the foldable electronic device) through the outside metal shield of the coaxial cable 1423 of the signal feeding line 142 or the electromagnetic wave signal is transmitted by the internal circuit (such as the internal circuit within the foldable electronic device) through the inner conductor of the coaxial cable 1421 of the signal feeding line 142 to the conductor 143 and then the electromagnetic wave signal is transmitted by the conductor 143. The outside metal shield of the coaxial cable 1423 is integrated with and is electrically connected to the outer housing (such as the housing of the foldable electronic device), the metal hinge 10, the metal joint plate 101, the metal joint plate 101′, the first metal connecting plate 12 and the second metal connecting plate 14 and are commonly grounded. With above components, the antenna loop is formed. It is emphasized that the signal feeding section 1432 is electrically connected to the inner conductor of the coaxial cable 1421 directly in the present invention. Obviously, the work bandwidth of the antenna loop has been matched when the signal feeding line 142 is fed into the electromagnetic wave signal. Thus, the hinge antenna 1 can apply for one of the third-generation mobile communications (3G) systems, Bluetooth systems and wireless broadband (Wi-Fi) system. The size and the configuration of the conductor 143 are not to be limited herein and can adjust according to the work bandwidth of the electromagnetic wave.

In addition, in order to insure the hinge antenna 1 that is fixedly connected to the foldable electronic device, a fixing plate 103 and an extension buckle 141 are alternatively arranged in the hinge antenna 1. One side of the fixing plate 103 is connected to the metal hinge 10 and another side of the fixing plate 103 is fixedly connected to the housing of the foldable electronic device. The extension buckle 141 is arranged extendedly along one side of the second metal connecting plate 14. In another preferred embodiment, the extension buckle 141 can cooperate to the foldable electronic device for combination that is extended vertically upward or downward to dispose along one side of the second metal connecting plate 14. Moreover, the extension buckle 141 further includes a buckle hole 1411 that is used for engaging with the housing of the foldable electronic device. Therefore, with the design of the fixing plate 103 and the extension buckle 141, the hinge antenna 1 can fixedly connect to the foldable electronic device.

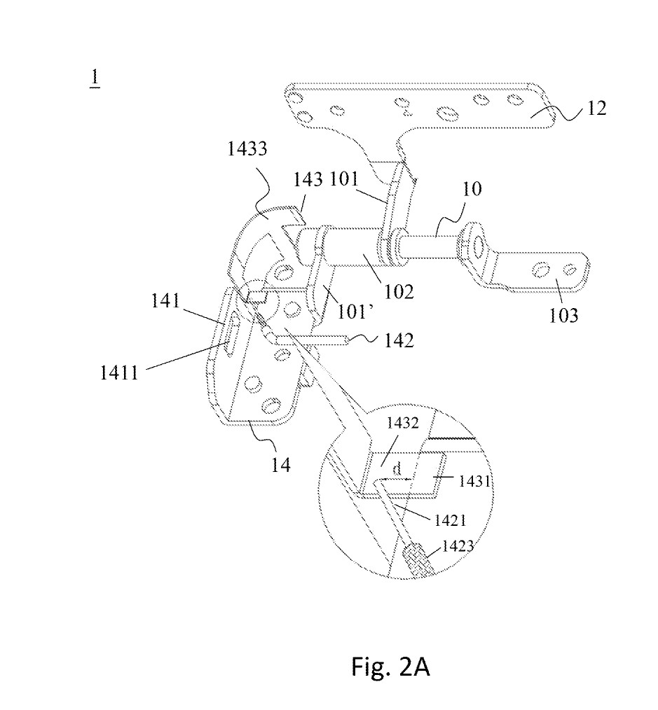

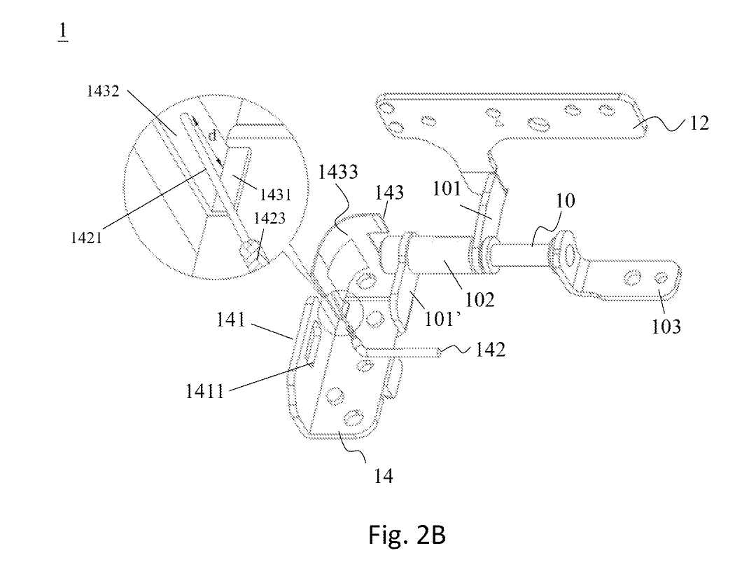

Next, please refer to FIG. 2A. FIG. 2A is a schematic view of another hinge antenna according to the first embodiment of the present invention. The structure in FIG. 2A is similar to aforementioned structure in FIG. 1 and thus it is not described herein. The different is that the conductor 143 is a planar inverted-F antenna or a loop antenna. The conductor 143 includes a connecting section 1431, a signal feeding section 1432 and a radiation section 1433. The connecting section 1431 is fixedly connected to the second metal connecting plate 14 and is connected to one end of the signal feeding line 142 through the signal feeding section 1432. The conductor 143 is received and transmitted the electromagnetic wave signal from the radiation section 1433 that is extended from the signal feeding section 1432. The conductor 143 can cooperate to the foldable electronic device for combination that is extended vertically upward or downward to dispose along one side of the second metal connecting plate 14. The arrangement for the conductor 143 is not to be limited in the present invention. In addition, one end of the inner conductor of the coaxial cable 1421 of the signal feeding section 142 is electrically connected to the signal feeding section 1432 of the conductor 143 and the outside metal shield of the coaxial cable 1423 of the signal feeding line 142 is electrically connected to the second metal connecting plate 14 (as for electrically connecting to the ground line). Because there is a distance “d” between the electrically connecting position of the inner conductor of the coaxial cable 1421 and that of the second metal connecting plate 14, the distance “d” can achieve the purpose for adjusting the impedance matching and can prevent the short circuit of the inner conductor of the coaxial cable 1421 from the radiation influence of the second metal connecting plate 14 for receiving and transmitting the electromagnetic wave signal. The distance “d” is range from 5 mm to 10 mm or a longer distance.

Please refer to FIG. 2B. FIG. 2B is a further schematic view of the hinge antenna according to a first embodiment of the present invention. It is clearly to obtain the different between FIG. 2A and FIG. 2B is that the position of the signal feeding section 1432. However, this is merely change in the position of the signal feeding section 1432 and the position of the signal feeding section 1432 is not limited herein. The signal feeding section 1432 is still arranged on the conductor 143 and is electrically connected to the signal feeding section 1432 of the conductor 143 through one end of the inner conductor of the coaxial cable 1421 of the signal feeding line 142 and the outside metal shield of the coaxial cable 1423 of the signal feeding line 142 is electrically connected to the second metal connecting plate 14 (as for electrically connecting to the ground line). Because there is a distance “d” between the electrically connecting position of the inner conductor of the coaxial cable 1421 of the signal feeding line 142 and that of the second metal connecting plate 14, the distance “d” can achieve the purpose for adjusting the impedance matching and can prevent the short circuit of the inner conductor of the coaxial cable 1421 from the radiation influence of the second metal connecting plate 14 for receiving and transmitting the electromagnetic wave signal. The distance “d” is range from 5 mm to 10 mm or a longer distance.

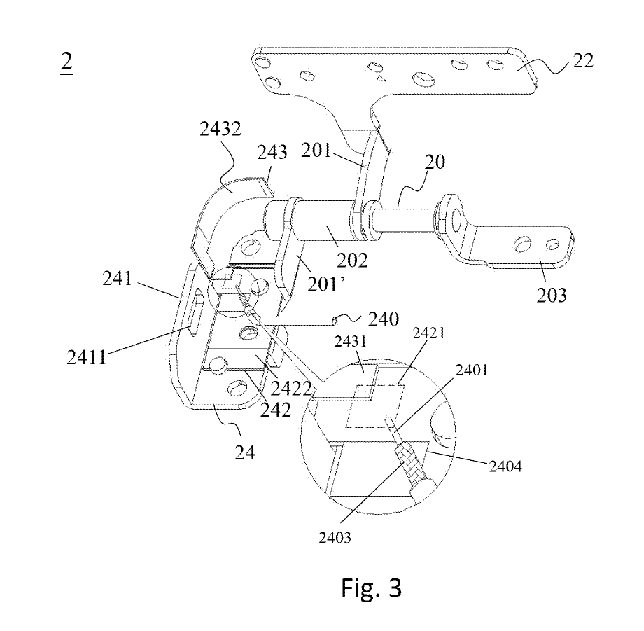

Next, please refer to FIG. 3. FIG. 3 is a schematic view of a hinge antenna according to a second embodiment of the present invention. As shown in FIG. 3, a hinge antenna 2 includes a metal hinge 20, a first metal connecting plate 22 and a second metal connecting plate 24. One end of the first metal connecting plate 22 and one end of the second metal connecting plate 24 is connected to a metal joint plate 201 and a metal joint plate 201′ respectively. The metal hinge 20 is jointed the first metal connecting plate 22 through the metal joint plate 201 and the metal hinge 20 is jointed the second metal connecting plate through the metal joint plate 201′. The metal hinge 201′ further includes a metal shaft 202 and the metal shaft 202 is penetrated through the metal joint plate 201 and the metal joint plate 201′ such that the first metal connecting plate 22 and the second metal connecting plate 24 are rotated by the metal shaft 202 with respect to the metal hinge 20. Above metal hinge 20, the first metal connecting plate 22, the metal joint plate 201, the metal joint plate 201′ and the second metal connecting plate 24 are formed by stamping the metallic materials. A plurality of through holes (not shown) in the first metal connecting plate 22 and the second metal connecting plate 24 is used for locking with the outer housing (such as housing of the foldable electronic device). Similarly, the size and the configuration of the first metal connecting plate 22 and the second metal connecting plate 24 are not limited in the embodiment of the present invention.

In addition, hinge antenna 2 further includes a signal feeding line 240, a microwave substrate 242 and a conductor 243, in which the signal feeding line 240 is provided for feeding an electromagnetic wave signal, the microwave substrate 242 is fixed to the second metal connecting plate 24 but the fixing manner is not limited herein. The microwave substrate 242 further includes a signal feeding section 2421 and a grounding section 2422, in which one end of the signal feeding section 2421 is electrically connected to one end of the signal feeding line 240 and the grounding section 2422 is electrically connected to the second metal connecting plate 24. The conductor 243 is arranged on the microwave substrate 242 and is electrically connected to another end of the signal feeding section 2421. In one preferred embodiment of the present invention, the microwave substrate 242 can be a printed circuit board (PCB) and the signal feeding section 2421 on the PCB is a signal pad sp as to selectively form a matching circuit. The matching circuit is a LC circuit which is constructed by an inductor and a capacitor. Thus, with the design of the impedance of the LC circuit to achieve the selection or adjustment of the electromagnetic wave signal which is matched. Further, the conductor 243 is formed by metallic material with geometric configuration. The conductor 243, the metal hinge 20, a first metal connecting plate 22 and a second metal connecting plate 24 are configured to form a monopole antenna. The conductor 243 further includes a connecting section 2431 and a radiation section 2432, in which the conductor 243 is electrically connected to one end of the signal feeding section 2421 on the microwave substrate 242 through the connecting section 2431 and is arranged and extended outwardly. The conductor 243 is received and transmitted the electromagnetic wave signal through the radiation section 2432. In one preferred embodiment, the conductor 243 can cooperate to a foldable electronic device for combination and the conductor 243 is extended vertically upward or downward along one side of the microwave substrate 242. The conductor 243 is fixed on the microwave substrate 242 by welding or is directly integrated with the microwave substrate 242. It is not limited in the present invention. Moreover, when the signal feeding line 240 is a coaxial cable, the coaxial cable is constructed by a pair of an inner conductor of the coaxial cable 2401 that is isolated from an outside metal shield of the coaxial cable 2403 and an insulated shielding layer (not shown in FIG. 3) covered outside of the coaxial cable. The inner conductor of the coaxial cable 2401 of the signal feeding line 240 is electrically connected to a signal feeding section 2421 of the conductor 243 and the outside metal shield of the coaxial cable 2403 of the signal feeding line 240 is electrically connected to the microwave 242 (as for electrically connecting to the ground line) through a fixing pad 2404 to prevent the short circuit of the inner conductor of the coaxial cable 2401 from the radiation influence is introduced by the microwave substrate 242 for receiving or transmitting the electromagnetic wave signal. Obviously, when the outside metal shield of the coaxial cable 2403 of the signal feeding line 240 is electrically connected to the microwave substrate 242 through the fixing pad 2404, the outside metal shield of the coaxial cable 2403 of the signal feeding line 240, the metal hinge 20, the metal joint plate 201, the metal joint plate 201′, the first metal connecting plate 22 and the second metal connecting plate 24 are integrated with an outer housing (such as housing of the foldable electronic device) and are commonly grounded when the metal hinge 20, the metal joint plate 201, the metal joint plate 201′, the first metal connecting plate 22 and the second metal connecting plate 24 are formed by stamping the metallic materials.

According to aforementioned, after adjusting the work bandwidth of the electromagnetic wave signal with the matching circuit, the electromagnetic wave signal is fed into the inner conductor of the coaxial cable 2401 of the signal feeding line 240 and then is transmitted into the internal circuit (such as an internal circuit within the foldable electronic device) or the inner conductor of the coaxial cable 2401 of the signal feeding line 240 transmits the electromagnetic wave signal that is further adjusted by the matching circuit to the conductor 243. The outside metal shield of the coaxial cable 2403 is integrated with the components of the outer housing (such as the housing of the foldable electronic device) and are commonly grounded, in which the components such as metal shaft 20, the metal joint plate 201, the metal joint plate 201′, the first metal connecting plate 22 and the second metal connecting plate 24. Thus, with the above components to constructs an antenna loop. It is emphasized that the matching circuit is used for adjusting the work bandwidth. Thus, the hinge antenna 2 can apply for one of the third-generation mobile communications (3G) systems, Bluetooth systems and wireless broadband (Wi-Fi) system. The size and the configuration of the conductor 243 are not to be limited herein and can adjust according to the work bandwidth of the electromagnetic wave.

In addition, in order to insure the hinge antenna 2 that is fixedly connect to the foldable electronic device, a fixing plate 203 and an extension buckle 241 are arranged in the hinge antenna. One side of the fixing plate 203 is connected to the metal hinge 20 and another side of the fixing plate 203 is fixedly connected to the housing of the foldable electronic device. The extension buckle 241 is arranged extendedly along one side of the second metal connecting plate 24. In one preferred embodiment, the extension buckle 241 can cooperate to the foldable electronic device for combination, which is extended vertically upward or downward along one side of the second metal connecting plate 24. In addition, the extension buckle 241 further includes a buckle hole 2411 which is provided for engaging with the foldable electronic device. With the design of the hinge antenna fixedly connected to the fixing plate 203 and the extension buckle 241, the hinge antenna 2 is more fixedly connected to the foldable electronic device.

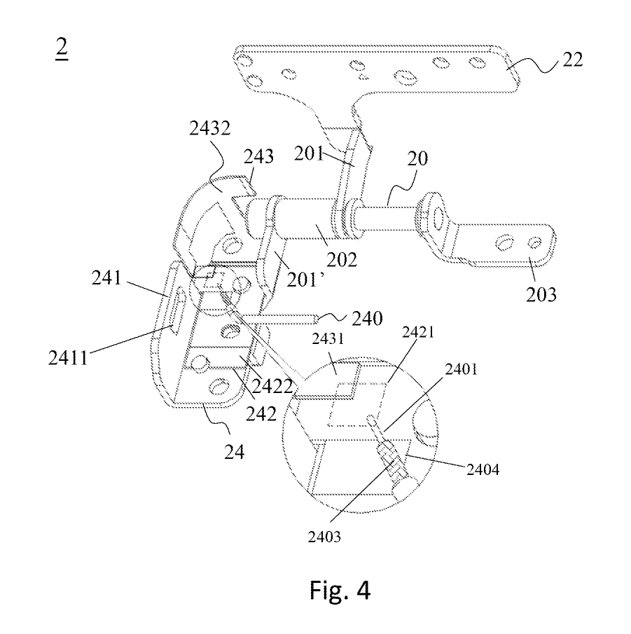

Please refer to FIG. 4. FIG. 4 is another schematic view of the hinge antenna according to the second embodiment of the present invention. The structure in FIG. 4 is similar to aforementioned structure in FIG. 3 and it is not described herein. The different is that the conductor 243 is a planar inverted-F antenna or a loop antenna. The conductor 243 also includes a connecting section 2431 and a radiation section 2432, in which the conductor 243 is electrically connected to one end of the signal feeding section 2421 on the microwave substrate 242 through the connecting section 2431 and the conductor 243 is arranged extendedly outward. The conductor 243 received and transmitted the electromagnetic wave signal through the radiation section 2432 and the desired electromagnetic wave signal is adjusted or selected by the matching circuit. In one preferred embodiment, the conductor 243 can cooperate to a foldable electronic device for combination, the conductor 243 is extended vertically upward or downward along one side of the microwave substrate 242 and it is not limited in this embodiment. In addition, the inner conductor of the coaxial cable 2401 of the signal feeding line 240 is electrically connected to the signal feeding section 2421 of the conductor 243. The outside metal shield of the coaxial cable 2403 of the signal feeding line 240 is connected to the microwave substrate 242 through the fixing pad 2404 (as for electrically connecting to the ground line) to prevent the short circuit of the inner conductor of the coaxial cable 2401 from the radiation influence is introduced by the microwave substrate 242 for receiving or transmitting the electromagnetic wave signal.

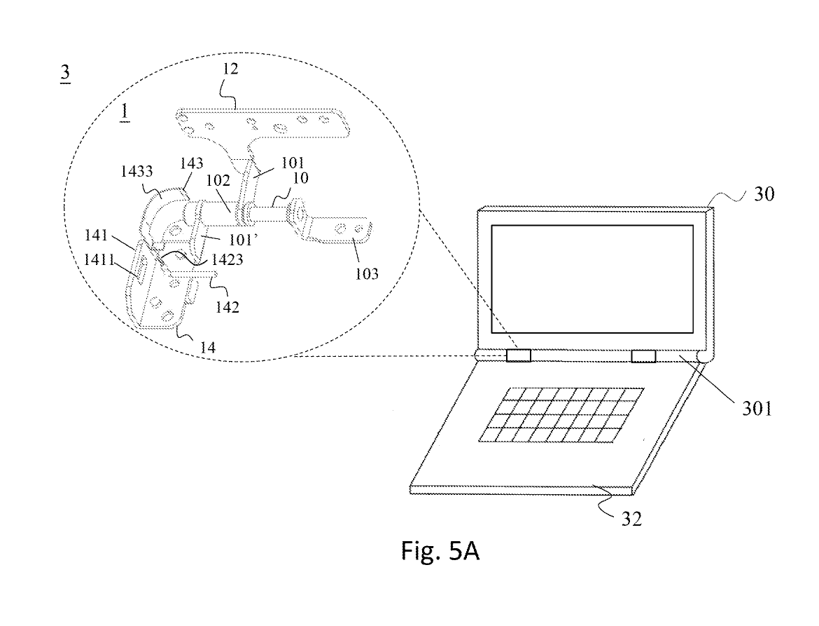

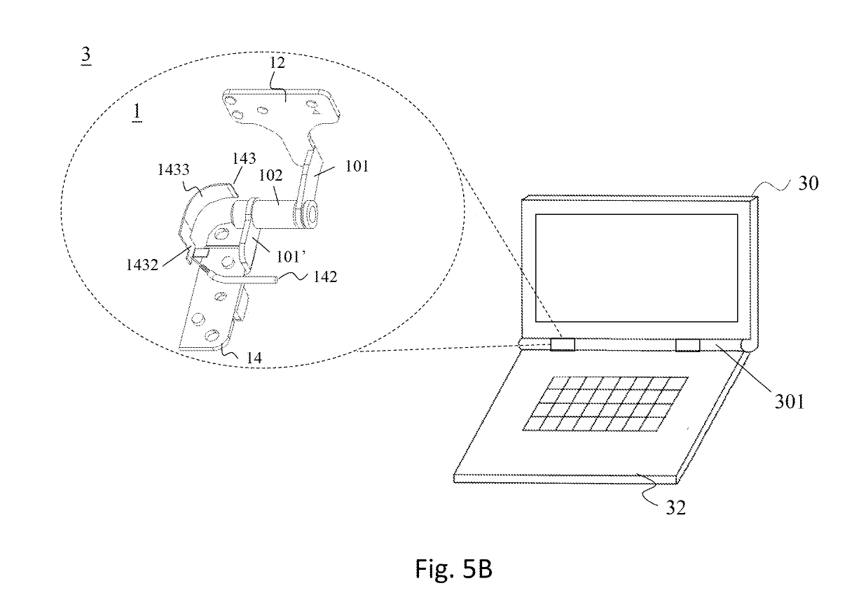

Then, please refer to FIG. 5A. FIG. 5A is a schematic view showing the application of the first embodiment in a foldable electronic device according to the present invention. As shown in FIG. 5A, the foldable electronic device 3 includes at least a hinge means 301, a first housing 30 and a second housing 32, in which the first housing 30 is integrated with the second housing 32 through the hinge means 301, such that the first housing 30 and the second housing 32 are rotationally displacement with respect to the hinge means 301 as the center. In one embodiment of the present invention, the foldable electronic device 3 is a laptop and the first housing 30 is a housing for accommodating the display of the laptop and the second housing 32 is a hosing for accommodating the keyboard and the motherboard of the laptop. The feature of the present invention is that a metallic block antenna integrated with the hinge means 301 to construct a hinge antenna 1 such that the hinge antenna 1 combined with the hinge means 301 can provide a function of torque which is required for the rotation of the first housing 30 and the second housing 32 and is capable of the antenna function. The structure of the hinge antenna 1 is combined with above hinge means 301 that is similar to the first embodiment of the hinge antenna 1 (as shown in FIG. 1) and it is not described herein.

When the hinge antenna 1 (as shown in FIG. 1) of the first embodiment is arranged on the foldable electronic device 3, the hinge means 301 is replaced with the metal hinge 10 and the metal hinge 10 is connected to the first metal connecting plate 12 and the second metal connecting plate 14 in the hinge antenna 1 and the fixing plate 103 connected to the metal hinge 10 which is connected to the first housing 30 or the second housing 32. It should be expressed that the connection manner between the first metal connecting plate 12, the second metal connecting plate 14 and the first housing 30 and the second housing of the foldable electronic device 3 is not limited and the connection manner can be adjusted according to the design of the foldable electronic device 3. For example, when the second metal connecting plate 14 is fixedly connected to the first housing 30, the conductor 143 of the hinge antenna 1 is to be arranged on one side of the first housing 30. When the second metal connecting plate 14 is fixedly connected to the second housing 32, the conductor 143 of the hinge antenna 1 is arranged on one side of the second housing 30. In order to insure the hinge antenna 1 that is fixedly connected to the foldable electronic device, the present invention selectively provides an extension buckle 141 that is arranged and is extended vertically upward or downward along one side of the second metal connecting plate 14. In addition, there is a buckle hole 1411 is arranged on the extension buckle 141 which is provided for engaging with the housing of the foldable electronic device such that the hinge antenna 1 is more fixedly connected to the foldable electronic device.

In addition, the material of the first housing 30 or that of the second housing 32 are not limited in the present invention, and thus the material can select all of the metallic housing; alternatively, one is metallic housing and another one is non-metallic housing. For the conductor 143 is capable of receiving and transmitting electromagnetic wave signal, the area relative to one side of the conductor 143 requires the non-metallic materials to avoid the shielding effect to create the shielding effect to cause the reception and the transmission of electromagnetic wave signal of the conductor 143 cannot be achieved. In addition, when more than one pair of the hinge means 301 on the foldable electronic device, the hinge antenna 1 of the present invention can selectively arrange on one of the hinge means 301 and it is also not to be limited.

In addition, the metal hinge 10, the metal joint plate 101, the metal joint plate 101′, the first metal connecting plate 12 and the second metal connecting plate 14 of the hinge antenna 1 of this embodiment are made by stamping the metallic plate. Thus, when the first metal connecting plate 12 or the second metal connecting plate 14 is connected to the first housing 30 or the second housing 32 and the outside metal shield of the coaxial cable 1423 of the signal feeding line 142 is connected to the second metal connecting plate 14 which means the outside metal shield of the coaxial cable 1423 of the signal feeding line 142 is integrated with the metal hinge 10, the metal joint plate 101, the metal joint plate 101′, the first metal connecting plate 12, the second metal connecting plate 14, the first housing 30 or the second housing and are commonly grounded. It is emphasized that one end of the conductor 143 is electrically connected to one end of the signal feeding line 142 directly in the foldable electronic device 3 of the present invention. Obviously, the work bandwidth for the antenna loop has been matched when the electromagnetic wave signal is fed into the signal feeding line 142. Thus, the hinge antenna 1 can apply for one of the third-generation mobile communications (3G) systems, Bluetooth systems and wireless broadband (Wi-Fi) system. The size and the configuration of the conductor 143 are not to be limited herein and can adjust according to the work bandwidth of the electromagnetic wave.

Because the conductor 143 can arrange extendedly on the second metal connecting plate 14 and the conductor 143, the metal hinge 10, the first metal connecting plate 12 and the second metal connecting plate 14 to construct a planar inverted-F antenna design and thus, there is no need to additionally install a micro-scale antenna that may influence the quality of electromagnetic signal transmission and reception. As resulted, the effects of structure stabilization, assembly simplification and appearance unification can be achieved.

Please refer to FIG. 5B. is another schematic view showing the application of the first embodiment in a foldable electronic device according to the present invention. It is obviously to obtain that the different is to reduce the design for connecting the fixing plate and extension buckle to the foldable electronic device and to change the configuration of the conductor 143 and the position of the signal feeding line 1432. Herein, this embodiment is merely cooperated with the foldable electronic device to be changed for combination, and the signal feeding section 1432 is still arranged on the conductor 143 and is electrically connected to one end of the signal feeding line 142 and by changing the distance “d” to achieve the purpose of the impedance matching. It is expressed that the size and configuration of the conductor 143 are not limited and the position of the signal feeding section 1432 is also not limited. The connections for the first metal connecting plate, the second metal connecting plate and the conductor are not limited, and the construction of the foldable electronic device is similar to above FIG. 5A and it is not to be described.

The conductor 243 can arranged extendedly on the microwave substrate 242 and the conductor 243, the metal hinge 10, the first metal connecting plate 12 and the second metal connecting plate 14 are configured to form a planer inverted-F antenna and there is no need to additionally install a micro-scale antenna that may influence the quality of electromagnetic signal transmission and reception. As resulted, the effects of structure stabilization, assembly simplification and appearance unification can be achieved.

In addition, the hinge antenna 1 of the first embodiment is arranged within the foldable electronic device 3 and is cooperated to the construction of the foldable electronic device for combination to selectively adjust the connection design of the foldable electronic device. It is emphasized that there in not limit to the hinge antenna 1 arrange in the foldable electronic device and the hinge antenna 2 of the second embodiment can also arrange in the foldable electronic device 3 and according to the combination of the foldable electronic device for selectively adjusting the connection design of the foldable electronic device.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A hinge antenna having a metal hinge, a first metal connecting plate and a second metal connecting plate, one end of the first metal connecting plate and one end of the second metal connecting plate are connected to a metal joint plate respectively, the metal hinge plate is jointed the first metal connecting plate and the second metal connecting plate through the metal joint plate and the metal hinge having a metal shaft which is arranged on the metal joint plate and the first metal connecting plate and the second metal are rotated with respect to the metal hinge, the hinge antenna comprising:
a signal feeding line, which is provided for feeding an electromagnetic wave signal; and
a conductor, which is arranged on the second metal connecting plate and is electrically connected to one end of the signal feeding line, wherein the conductor is made by a metallic material with geometric configuration.

2. The hinge antenna according to claim 1, wherein the conductor further comprises:
a connecting section, which is connected to the second metal connecting plate;
a signal feeding section, which is electrically connected to one end of the signal feeding line; and
a radiation section, which is extended from the signal feeding section and is provided for receiving and emitting the electromagnetic wave signal.

3. A hinge antenna having a metal hinge, a first metal connecting plate, and a second metal connecting plate, one end of the first metal connecting plate and one end of the second metal connecting plate is connected to a metal joint plate respectively, the metal hinge is jointed the first metal connecting plate and the second metal connecting plate by the metal joint plate, the metal hinge includes a metal shaft which is arranged in the metal joint plate and the first metal connecting plate and the second metal are rotated with respect to the metal hinge, the characteristic of the hinge antenna in that:
a signal feeding line, which is provided for feeding an electromagnetic wave signal;
a microwave substrate, which is arranged on the second metal connecting plate, the microwave substrate having a signal feeding section and a grounding section, and one end of the signal feeding section is electrically connected to one end of the signal feeding line, and the grounding section is electrically connected to the second metal connecting plate; and
a conductor, which is arranged on the microwave substrate and is electrically connected to another end of the signal feeding section, wherein the conductor is made by a metallic material with geometric configuration.

4. The hinge antenna according to claim 3, wherein the conductor further comprises:
a connecting section, which is electrically connected to the microwave substrate; and
a radiation section, which is extended from the signal feeding section and is provided for receiving and emitting the electromagnetic wave signal.

5. A foldable electronic device having a hinge antenna, a first housing and a second house, the hinge antenna having a metal shaft, a first metal connecting plate and a second metal connecting plate, one end of the first metal connecting plate and one end of the second metal connecting plate is connected to a metal joint plate respectively, the metal hinge is connected to the first metal connecting plate and the second metal connecting plate through the metal joint plate, the metal hinge further having a metal shaft which is arranged on the metal joint plate and the first metal connecting plate and the second metal are rotated with respect to the metal hinge, wherein the first housing and the second housing is fixed to the first metal connecting plate and the second metal connecting plate respectively, such that the first housing and the second housing are rotationally displaced with respect to the metal shaft, the characteristic of the hinge antenna comprising in that:
a signal feeding line, which is provided for feeding an electromagnetic wave signal; and
a conductor, which is arranged on the second metal connecting plate and is electrically connected to one end of the signal feeding line, wherein the conductor is made by a metallic material with geometric configuration.

6. The foldable electronic device according to claim 5, wherein the conductor further comprises:
a connecting section, which is electrically connected to the second metal connecting plate;
a signal feeding section, which is electrically connected to one end of the signal feeding line; and
a radiation section, which is extended from the signal feeding section and is provided for receiving and emitting the electromagnetic wave signal.

7. The foldable electronic device according to claim 5, wherein the hinge antenna further comprises:
a fixing plate having one end is connected to the metal shaft and another end is fixed on the second housing; and
an extension buckle, which is extended vertically upward or downward from one side of the second metal connecting plate and having a buckle hole for engaging with the first housing.

8. The foldable electronic device according to claim 5, wherein the first housing is a housing for accommodating a display and the second housing is a housing for accommodating a keyboard and a motherboard.

9. A foldable electronic device having a hinge antenna, a first housing and a second housing, the hinge antenna having a metal hinge, a first metal connecting plate and a second metal connecting plate, one end of the first metal connecting plate and one end of the second metal connecting plate is connected to the metal joint plate respectively, the metal hinge is jointed the first metal connecting plate and the second metal connecting plate through the metal joint plate, the metal hinge further includes a metal shaft which is arranged on the metal joint plate and the first metal connecting plate and the second metal connecting plate are rotated by the metal shaft with respect to the metal hinge, wherein the first housing and the second housing is fixed on the first metal connecting plate and the second metal connecting plate respectively, such that the first housing and the second housing are rotationally displaced with respect to the metal shaft, the characteristic of the hinge antenna in that:
a signal feeding line, which provided for feeding an electromagnetic wave signal;
a microwave substrate, which is arranged on the second metal connecting plate and having a signal feeding section and a grounding section, one end of the signal feeding section is electrically connected to one end of the signal feeding line and the grounding section is electrically connected to the second metal connecting plate; and
a conductor, which is arranged on the microwave substrate and is electrically connected to another end of the signal feeding section, wherein the conductor is made by a metallic material with geometric configuration.

10. The hinge antenna according to claim 9, wherein the conductor further comprises:
a connecting section, which is connected to the microwave substrate; and
a radiation section, which is extended from the signal feeding section and is provided for receiving and emitting the electromagnetic wave signal.

11. The hinge antenna according to claim 9, wherein the hinge antenna further comprises:
a fixing plate having one end is connected to the metal shaft and another end is fixed on the second housing; and
an extension buckle, which is extended vertically upward or downward from one side of the second metal connecting plate and having a buckle hole for engaging with the first housing.

12. The hinge antenna according to claim 9, wherein the first housing is a housing for accommodating a display and the second housing is a housing for accommodating a keyboard and a motherboard.
